(19) United States
(12) Patent Application Publication
(10) Pub. No.: US 2009/0107757 A1
(43) Pub. Date: Apr. 30, 2009

(54) Acoustic Isolator

(75) Inventors: Henry Paul Lindner, The Woodlands, TX (US); Yibing Zheng, Houston, TX (US)

Correspondence Address: Bracewell & Giuliani LLP, P.O. Box 61389, Houston, TX, 77208-1389, US

(73) Assignee: Baker Hughes Incorporated, Houston, TX (US)

(21) Appl. No.: 12/255,964

(22) Filed: Oct. 22, 2008

Related U.S. Application Data
(60) Provisional application No. 60/982,346, filed on Oct. 24, 2007.

(51) Int. Cl. G01V 1/44; G01V 1/40

(52) U.S. Cl. 181/102; 181/106

(57) ABSTRACT

An acoustic isolator for use with downhole subterranean exploration and production operations, where the operations transmit acoustic signals into a subterranean formation. The acoustic isolator comprises a series of threaded fittings and is disposed on a downhole tool between a transmitter and a receiver. The acoustic isolator substantially attenuates the acoustic signal along the body and minimizes its effect on the receiver.

### RELATED APPLICATIONS

This application claims priority to and the benefit of co-pending U.S. Provisional Application Ser. No. 60/982,346, filed Oct. 24, 2007, the full disclosure of which is hereby incorporated by reference herein.

### BACKGROUND OF THE INVENTION

1. Field of the Invention

The disclosure herein relates generally to the field of investigating subterranean formations. More specifically, the present disclosure relates to acoustically interrogating subterranean formations employing an acoustic isolator. Yet more specifically, the present disclosure relates to downhole acoustic investigations with an acoustic isolator comprising a series of threaded fittings.

2. Description of Related Art

Logging tools having acoustic transmitters and receivers are used in the exploration and interrogation of subterranean wellbores. Wellbore imaging with these acoustic devices is useful for both cased and uncased wellbores. Typically, these acoustic logging tools emit an acoustic signal into the surrounding formation with the transmitting transducer, then receive and measure the resulting acoustic signal by an acoustic receiver disposed on the tool. Thus one example of wellborn imaging comprises passing acoustic signals through a formation adjacent a wellbore and recording the signal after it has propagated through at least a portion of the formation. The recorded acoustic wave can then be analyzed in order to determine information regarding this formation. Information of interest can be the travel time of the wave through the media as well as attenuation of the acoustic signal.

These acoustic transmitters and receivers have been found useful on drill strings such that this logging may occur while drilling (LWD). Optionally, these devices may be employed on a logging tool, also referred to herein as a sonde, wherein the tool is inserted in the wellbore in order to analyze the subterranean formation.

FIG. 1A is a partial sectional view illustrating a logging while drilling operation; the drilling operations include a drill string 12 shown forming a wellbore 10 using a bit 14 on its lower end. The bit 14 is shown as a general roller cone bit drilling through a subterranean rock 16. However, other types of bits, such as drag bits and fixed bits can be used in this application. Drill strings typically comprise multiple lengths of threaded pipe fitted or coupled together to form an elongated rotating member that provides a rotational force on the bit 14 for drilling purposes. Integral within the drill string is an imaging system 17 having a transmitter 18 suitable for creating an acoustic signal (shown by the arrow A1) that propagates throughout the formation 8. In this embodiment, the signal is to be recorded and registered by a receiver 20 disposed within the imaging system 17 a fixed distance away from the transmitter 18. Knowing the fixed distance between these two transducers, enables a close estimation of the signal velocity through the formation 8.

Due to their acoustic nature, the signals not only propagate through the formation 8 but can also make their way along the string 12 and imaging system 17. These signals are referred to herein as tool mode signals A2 and are illustrated by arrows passing from adjacent the transmitter 18 up the string 12 and system 17. If allowed to travel unobstructed along the imaging system 17, the tool mode signal A2 would arrive at the receiver 20 prior to the signal mode A1. Tool mode signals A2 are stronger than the signals A1 passing through the formation and override and mix with formation signals thereby making the signal data difficult to identify and/or analyze. Accordingly, acoustic isolators are provided for attenuating or intercepting tool mode signals before they can interfere with the formation signals at the receiver. In the embodiment of the drill string of FIG. 1, an acoustic isolator 22 is shown formed along the drill string between the receiver and transmitter. Examples of acoustic isolators may be found in Redding et al., U.S. Pat. No. 6,820,716 and Egerev et al., U.S. Pat. No. 7,032,707.

With reference now to FIG. 1B, a downhole tool 24 such as a logging device or wellbore imaging device is shown inserted within a wellbore 11. The wellbore 11 can be cased or uncased. Similar to the drill string embodiment, the downhole tool includes a transmitting transducer 18a with a corresponding receiving transducer 20a. Both the tool mode signal A2 and signal mode A1 are shown propagating between the transmitter and the receiver. Also included with the downhole tool is an acoustic isolator 22a provided to impede tool mode signal A2 propagation to the receiver 20a.

### BRIEF SUMMARY OF THE INVENTION

Disclosed herein is a downhole tool comprising, an acoustic isolator for use in a subterranean exploration, wherein the acoustic isolator comprises coaxially arranged segments, wherein each segment includes a threaded portion. Adjacent segments are coupled to one another on the threaded portion. This threaded portion coupling thereby forms a threaded connection. In one embodiment, the threaded connection comprises male threads formed on the threaded portion of the first segment and female threads formed on a threaded portion of the second segment. In another embodiment, the threaded connection comprises male threads formed on both of the corresponding adjoining ends of adjacent segments and a coupling threadingly connecting the adjoining ends having the male threads. In another embodiment, the threaded connection comprises female threads on the corresponding adjoining ends of adjacent segments and a coupling threadingly connecting the adjoining female threaded ends.

The acoustic isolator may attenuate waves such as compressional waves, shear waves, Raleigh waves, Lamb waves, Stonely waves, and combinations thereof. The acoustic isolator is combinable with a downhole tool as well as a drill string. In one optional embodiment, the acoustic isolator comprises four threaded connections.

Another optional embodiment disclosed herein comprises a downhole member disposable in a wellbore, included with the downhole member is a transmitter, a receiver, and an acoustic isolator between the transmitter and receiver, where the acoustic isolator comprises a series of threaded connections. This embodiment includes options wherein the downhole member is a drill string as well as a wellbore imaging device.

Also included herein is a method of isolating acoustic signals along a downhole member, wherein the member includes a transmitter and receiver, the method comprises, inserting an acoustic isolator on the member between the transmitter and the receiver, wherein the acoustic isolator comprises a series of threaded connections. The method may further include disposing the downhole member in a wellbore that intersects a subterranean formation, directing an acoustic signal from the transmitter into the subterranean formation, and for receiving the signal with a receiver as it returns to the wellbore from the formation.

### A BRIEF DESCRIPTION OF THE SEVERAL VIEWS OF THE DRAWING

FIG. 1 is a prior art example illustrating both a drill string and a logging tool disposed in wellbores, wherein each of the drill string and logging tool emit signals into the formation around the wellbore.

FIG. 2 comprises a perspective cutaway view of an embodiment of an acoustic isolator in accordance with the present disclosure.

FIG. 3 is a cutaway view of an acoustic isolator as used in conjunction with a downhole tool disposed in a wellbore.

### DETAILED DESCRIPTION OF THE INVENTION

Disclosed herein is an acoustic isolator for use with acoustic wellbore imaging devices. The isolator can be used on any tool used in wellbore imaging, examples include a drill string and wellbore logging tools. The acoustic isolator may be disposed on the downhole member, wherein the member includes an acoustic transmitter and receiver. The acoustic isolator disclosed herein comprises a threaded connection between these two acoustic transducers for attenuating and blocking any tool mode signal that may propagate along the tool between the transmitter and receiver.

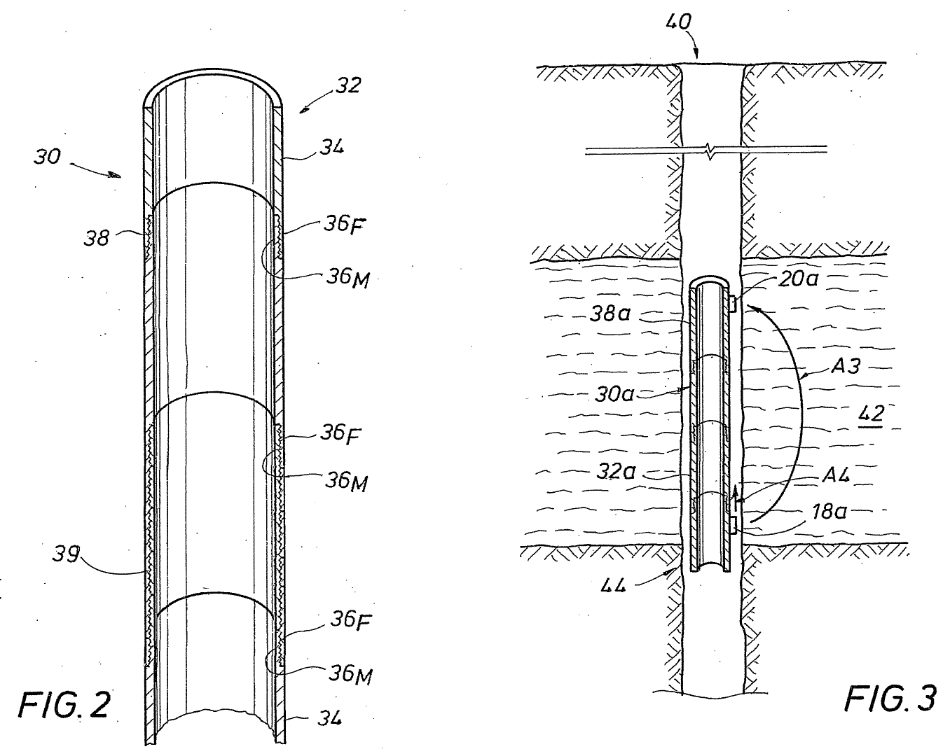

FIG. 2 provides a sectional view of an embodiment of a portion of an acoustic isolator in accordance with the present disclosure is shown. In this embodiment, the acoustic isolator 30 comprises coaxially arranged segments 32. In the embodiment shown, the segments 32 are generally annular with a substantially circular profile and a hollowed out mid section. Each segment 32 comprises a body portion 34 with a threaded portion 36 on each end. The body portion 34, as shown, extends between respective threaded portions 36. Each threaded portion 36 includes threads 38 on at least one of an inner or an outer surface of the portion 36, where the threads 38 are substantially transverse to the isolator 30 axis. In one optional embodiment, one end of the segment 34 may have a substantially smooth unthreaded portion.

In the embodiment of FIG. 2, segments 32 have oppositely formed threads that may be coupled with the threads 38 of an adjacent segment 32. For example, upper segments 32 comprise a female threaded portion 36F mated to a male threaded portion 36M on a lower segment 32. In another embodiment each segment 32 could have the same type of threads but connected with a coupling; adjacent segments 32 could have a male threaded portion 36M affixed with a female coupling. Alternatively, female threaded portions 36F could be mated with a male coupling.

Optionally, a segment 32 threaded portion may extend substantially along its entire length such that the male threaded portion 36M and female threaded portion 36F on a segment 32 meet or overlap. Threads 39 represent an example of a segment 32 threaded along its entire length. Other embodiments exist wherein the threads 38 extend about 10% of the segment 32 length, about 20% of the segment 32 length, about 30% of the segment 32 length, about 40% of the segment 32 length, about 50% of the segment 32 length, about 60% of the segment 32 length, about 70% of the segment 32 length, about 80% of the segment 32 length, about 90% of the segment 32 length, or about 95% of the segment 32 length. Thread 38 travel is not limited to the above mentioned values, but can include any percentage of segment 32 length.

It has been discovered that a series of threaded couplings attenuate acoustic signals. Accordingly, acoustic signals can be significantly attenuated by an acoustic isolator 30 as disclosed herein formed from a series of threaded connections. Embodiments of the acoustic isolator 30 can operate with any type of acoustic transmitter therefore attenuating the acoustic signal emitted by the transmitter. Examples of acoustic transmitters include piezoelectric, wedge type, and electromagnetic acoustic transmitters (EMAT). The types of waves that the acoustic isolator 30 can attenuate include compressional waves, shear waves, Raleigh waves, Lamb waves, Stonely waves, as well as combinations of these waves.

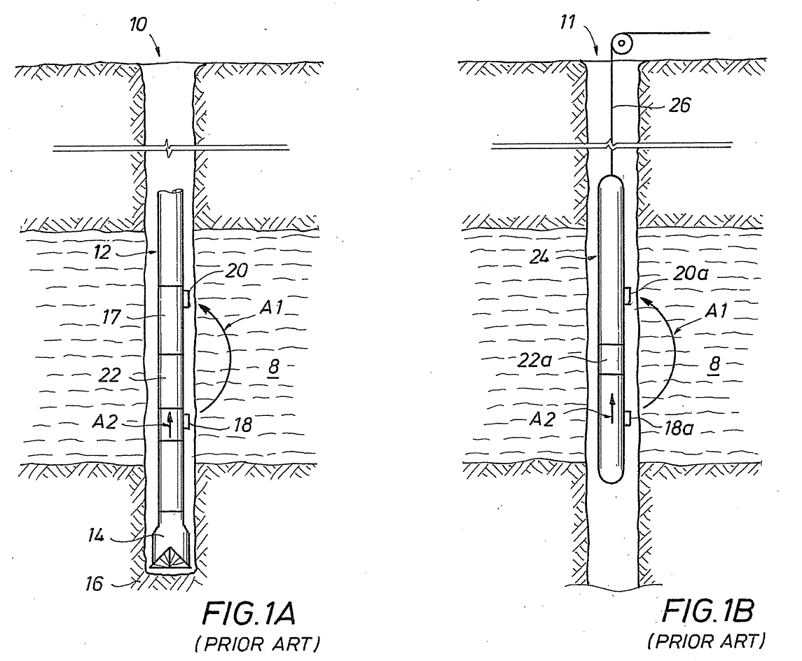

FIG. 3 illustrates a cross sectional view of a tool disposed in a wellbore 40 wherein the wellbore intersects a subterranean formation 42. Here, the segment of the downhole tool 44 includes an embodiment of an acoustic isolator 30a. As discussed, the downhole tool 44 may comprise a portion of a drilling string, a wellbore exploration tool, such as an imaging device (i.e., well logging tool) or any other wellbore device that may image the formation with or without acoustic transmitters. In this embodiment, an acoustic transmitter 18a is disposed on the outer surface of the wellbore tool 44. Signals, illustrated by arrows A3 and A4, propagate from the transmitter 18a towards an accompanying receiver 20a. The signal A3 propagates through the formation 42 and is received and recorded by the receiver 20a. In contrast, a tool mode signal A4 traversing the tool 44 is intercepted and attenuated by the acoustic isolator 30a. Optionally, an embodiment of the acoustic isolator 32 can be substituted in for the isolator 22, 22a in FIG. 1A or 1B to form a downhole system that includes a manner of blocking acoustic signal or wave propagation along the system.

As portrayed in FIG. 3, the acoustic isolator 30a comprises a series of segments 32a coaxially joined by threads 38a formed on each segment 32a. The embodiment of FIG. 3 depicts a series of six threaded connections; however alternatives exist having a series of three threaded connections and greater than six. In one embodiment, the threaded connections of an acoustic isolator are four threaded connections. In other embodiments, they may include five, six, seven, and upwards of that number.

Embodiments of a logging while drilling system with the acoustic isolator 30a described herein may be employed. In this embodiment, the acoustic isolator 30a would be disposed on an imaging system included within a portion of the drilling string. Thus, the imaging portion would include a section having an acoustic transmitter on a lower end with the acoustic receiver on the other end. The acoustic isolator section would be coupled between the section having the transmitter and the second having the receiver. It should be pointed out that the acoustic isolator disclosed herein is not limited to situations having a single transmitter and a single receiver but can include multiple receivers and multiple transmitters. The acoustic isolator 30a described herein is not limited to a single type of imaging device, but can be used with any type of well logging apparatus forming acoustic waves that are transmitted into a subterranean formation and later retrieved by a receiver.

A method is also included herein, where the method involves isolating acoustic signals along a downhole member. The downhole member may include a portion of a drilling device as well as any wellbore logging and/or imaging device. That method includes inserting an acoustic isolator 30a on an assembly between a transmitter and a receiver. The assembly is then inserted into a wellbore for wellbore operations. It may be used either during a logging while drilling operation as well as well bore imaging. In this embodiment, the acoustic isolator 30a comprises a series of threaded fittings such that tool wave signals cannot propagate across the acoustic isolator 30a. The acoustic isolator threaded fittings fully intercept or substantially attenuate tool mode signals or waves thereby preventing interference with signal waves received by the receiver from the formation.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. For example, control of the embodiments herein described may be performed by an information handling system, either disposed with the tool or at surface. Yet further optionally, the system and method disclosed herein includes a signal source for generating an acoustic wave that may be different from the transmitter 18, 18a and disposed away from the downhole tool or drill string, such as at surface, another wellbore, or elsewhere. These and other similar modifications will readily suggest themselves to those skilled in the art, and are intended to be encompassed within the spirit of the present invention disclosed herein and the scope of the appended claims.

What is claimed is:

1. A wellbore tool for use in subterranean exploration comprising:
a tool body;
an acoustic signal receiver with the tool body;
a signal source having a signal output directed towards the receiver; and
an annular acoustic isolator with the tool body disposed between the acoustic signal receiver and the signal source, the acoustic isolator comprising:
three coaxially arranged segments; and
a threaded portion provided on each segment, wherein adjacent segments are coupled to one another on the respective threaded portions thereby forming threaded connections.

2. The tool of claim 1, wherein the signal source comprises an acoustic transmitter with the tool.

3. The tool of claim 1, wherein the threaded portion extends substantially along the length of the segment.

4. The tool of claim 1, wherein the threaded connection comprises male threads formed on the corresponding adjoining ends of adjacent segments and a coupling threadingly connecting said adjoining ends.

5. The tool of claim 1, wherein the threaded connection comprises female threads formed on the corresponding adjoining ends of adjacent segments and a coupling threadingly connecting said adjoining ends.

6. The tool of claim 1, wherein the downhole tool comprises a type selected from the group consisting of a drill string and a wellbore imaging device.

7. The tool of claim 1, wherein the threads comprise a type selected from the group consisting of ANSI, UTS, UNC, UNF, UNEF, UNS, NPT, BSW, and BSPT.

8. A logging while drilling system comprising:
a drill string;
an acoustic transmitter disposed on the drill string;
an acoustic receiver disposed on the drill string;
an acoustic isolation device disposed on the drill string between the transmitter and receiver, wherein the acoustic isolation device comprises three coaxially arranged annular members having a threaded portion on an end, the members threadingly coupled together on respective threaded portions.

9. The logging while drilling system of claim 8, wherein at least one of the threaded portions extends substantially along the length of the respective segment.

10. The logging while drilling system of claim 8, comprising four segments.

11. The logging while drilling system of claim 8, wherein the threaded portions comprise threads selected from the group consisting of ANSI, UTS, UNC, UNF, UNEF, UNS, NPT, BSW, and BSPT.

12. A method of isolating acoustic signals along a downhole member, wherein the member comprises a transmitter and a receiver, said method comprising:
inserting an acoustic isolator on the member between the transmitter and the receiver, wherein the acoustic isolator comprises three annular members formed from segments, each segment having a threaded portion on an end, the members connected on the threaded portions;
disposing the downhole member in a wellbore formed through a subterranean formation;
directing an acoustic signal from the transmitter into the subterranean formation, so that when a portion of the acoustic signal propagates from the transmitter along the downhole member to form a tool mode signal, the tool mode signal is attenuated in the acoustic isolator before reaching the receiver; and
receiving the signal with the receiver as it returns to the wellbore from the subterranean formation.

13. The method of claim 12, wherein at least one of the threaded portions extends substantially along the length of the respective member.

14. The method of claim 12, wherein the downhole member comprises a type selected from the list consisting of a drilling string and a wellbore imaging device.
